(19) United States
(12) Patent Application Publication
(10) Pub. No.: US 2026/0344727 A1
(43) Pub. Date: Nov. 5, 2026

(54) SYSTEM AND METHOD FOR PRODUCING BAKED PLANT-BASED FOODS AS WELL AS VIBRATION OVEN

(71) Applicant: THE LORENZ BAHLSEN SNACK-WORLD GMBH & CO KG GERMANY, Neu-Isenburg (DE)

(72) Inventor: Holger SCHÄDLICH, Dreieich (DE)

(73) Assignee: THE LORENZ BAHLSEN SNACK-WORLD GMBH & CO KG GERMANY, Neu-Isenburg (DE)

(21) Appl. No.: 19/483,613

(22) PCT Filed: May 10, 2024
(86) PCT No.: PCT/EP2024/062996

§ 371 Date: Nov. 12, 2025

(30) Foreign Application Priority Data
May 12, 2023 (EP) 23173233.0

(51) Int. Cl. A23N 12/08; A23L 19/18; A23N 12/12

(52) U.S. Cl. CPC A23N 12/083; A23L 19/18; A23N 12/086; A23N 12/125

(57) ABSTRACT

The invention relates to a system (10) for producing baked plant-based foods (1), particularly baked potato chips, the system (10) comprising at least one pre-drying section (20) for pre-drying provided plant-based foods (1), in particular potato slices, and at least one baking section (40) for baking the pre-dried foods, wherein the pre-drying section (20) comprises a bottom (21) for receiving the plant-based foods (1), wherein the bottom (21) is configured to be set in vibration, and wherein the pre-drying section (20) comprises an energy supply unit (23) for pre-drying the plant-based foods (1) by supplying energy to the plant-based foods (1). The invention further relates to a method for producing baked plant-based foods (1) and a vibration oven (50).

The present invention relates to a system and a method for producing baked plant-based foods, particularly baked potato chips, as well as a vibration oven.

Baked plant-based foods enjoy great popularity worldwide and have become increasingly popular as consumers look for healthier and more sustainable food choices. However, the production of plant-based foods typically goes along with significant food waste due to inhomogeneous processing, which typically results from the fact that some fractions of the plant-based foods are exposed to different processing parameters than others, as individual plant-based foods comprised by the plant-based foods are difficult to control throughout the process. As a consequence, large fractions of the plant-based foods have to be sorted out and discarded, leading to inefficiencies and increased costs.

Based on this, it is subject of the present invention to provide a system and a method for producing baked plant-based foods as well as a vibration oven, which allow to reduce the amount of food waste due to inhomogeneous processing and to improve the flexibility of the processing, wherein the produced plant-based foods are visually, tastefully and texturally appealing to customers.

This task is solved by a system for producing baked plant-based foods with the features of claim 1, a method for producing baked plant-based foods with the features of claim 14 as well as a vibration oven with the features of claim 19.

Advantageous embodiments of the invention are given in the corresponding dependent claims and described in the following.

A first aspect of the invention relates to a system for producing baked plant-based foods, particularly baked potato chips. The system comprises at least one pre-drying section for pre-drying provided plant-based foods, in particular potato slices, and at least one baking section for baking the pre-dried foods. The pre-drying section comprises a bottom for receiving the plant-based foods, wherein the bottom is configured to be set in vibration, and wherein the pre-drying section comprises an energy supply unit for pre-drying the plant-based foods by supplying energy to the plant-based foods.

In the context of the present invention, the term “plant-based foods” in particular includes vegetables, potatoes, legumes, fruits, nuts, rice and/or cereals.

In the context of the present invention, the term “potato chips” relates to potatoes and particularly cut potatoes, such as potato slices that are processed, for example fried or dried, as the average customer knows them.

The pre-drying in the pre-drying section is on the one hand achieved by said vibration of the bottom, that is, mechanically. On the other hand, the pre-drying is further enhanced by means of the energy supplied to the plant-based foods by the energy supply unit. Said energy may comprise for example electromagnetic radiation, particularly thermal radiation and/or microwaves or other forms of energy, particularly as disclosed hereafter. As such, the plant-based foods are pre-dried in the pre-drying section both mechanically by means of the vibration of the bottom, as well as by the energy provided by the energy supply unit. Both the vibration as well as the energy supply may be controlled, particularly by means of an adjustment of a vibration amplitude and/or frequency of the vibration of the bottom as well as an adjustment of the amount of energy supplied to the plant-based foods by the energy supply unit. This measure contributes to enhanced control of the pre-drying of the plant-based foods in the pre-drying section.

In particular, the vibration of the bottom is such that the plant-based foods are lifted from the bottom. The vibration of the bottom may thus be so strong that the plant-based foods repeatedly and essentially randomly rotate and flip, which allows for a homogeneous drying process of the plant-based foods from all sides. This measure thus reduces the amount of food waste due to plant-based foods that are too moist or too dry.

The baking in the baking section may likewise be achieved by supplying energy from an energy supply unit to the pre-dried plant-based foods received by the baking section. To this end, the same energy supply unit used for pre-drying the plant-based foods in the pre-drying section, or a further energy supply unit may be used.

As such, the pre-drying and the baking are divided into separate processes performed in separate sections of the system, which increases the flexibility of the system: For instance, the baking process, such as a baking temperature and/or a baking time in the baking section may be adjusted based on a moisture content of the pre-dried foods determined during or upon the pre-drying in the pre-drying section.

Advantageously, the pre-drying and the baking replaces and thus does not include a frying the plant-based foods in fats such as oil, which reduces the fat content of the baked plant-based foods by 50% to 100%, particularly by 50% to 70%, which strongly improves their food safety. At the same time, the system and method according to the invention allows to fabricate plant-based foods that have a comparable texture and look compared to fried plant-based foods, while offering an appealing taste to customers.

According to an embodiment, a pre-drying temperature can be set in the pre-drying section by means of the energy supply unit and wherein the baking section is configured to set a baking temperature therein, in particular wherein a temperature gradient between the pre-drying temperature and the baking temperature can be set. Preferably, the baking temperature is lower than the pre-drying temperature. As an advantageous consequence besides the enhanced flexibility of the system, the proposed two-stage drying-baking process contributes to an improved food safety of the plant-based foods by reducing the amount of carcinogenic acrylamide, whose formation is typically enhanced at high temperatures in the presence of reducing sugars such as glucose and fructose and low moisture contents.

In another embodiment, the bottom of the pre-drying section comprises an outflow bottom through which the energy can be supplied to the plant-based foods.

In an embodiment, the energy supply unit is configured to generate a hot fluid stream, particularly a hot gas stream, more particularly a hot air stream, such that the plant-based foods can be pre-dried by the hot fluid stream. In particular, the plant-based foods are pre-dried by supercritical drying, or critical point drying. The plant-based foods can also be pre-dried by a superheated stream, particularly superheated steam, i.e. a stream or stream at a temperature higher than its vaporization point at the absolute pressure where the temperature is measured.

According to another embodiment, the hot fluid stream is directed through said outflow bottom. This embodiment is in particularly advantageous in that plant-based foods that are lifted by the vibration of the bottom may be pre-dried efficiently from all sides, as they randomness of the rotating and flipping plant-based foods is further enhanced by the hot fluid stream acting on the plant-based foods, which further reduces the amount of food waste due to plant-based foods that are too dry or too moist. Particularly, the hot fluid stream may contribute to the lifting of the plant-based foods from the outflow bottom.

In an embodiment, the pre-drying section further comprises a plurality of conveying sections separated from one another along a conveying direction extending through the pre-drying section, such that the plant-based foods are separable in volumes defined by the conveying sections. In particular, the separation is such that the plant-based foods arranged in different conveying sections cannot move from one conveying section to another through a physical barrier. A movement of plant-based foods from one conveying section to another may thus only happen if individual plant-based foods move around said physical barrier. For example, the conveying sections and their volumes may be defined by chambers which delimit the conveying sections. Typically, the production of baked plant-based foods based on air-frying goes along with a large amount of waste, since the baking time of individual plant-based foods comprised by the plant-based foods is not well controlled. This is because individual plant-based foods, for example individual potato slices, move essentially randomly in an airflow due to their different shapes and the flow dynamics of the airflow. This causes an essentially Gaussian distribution of individual plant-based foods with regard to the baking time. Typically, 50%, particularly 50% to 90% of the individual plant-based foods are baked with acceptable tolerances around a pre-determined baking time, 5% to 25% of the slices are a too moist, that is, have passed through the system too fast and 5% to 25% of the slices are too dry, that is, have passed through the system too slowly. Ideally, the respective fractions of plant-based foods that are too moist or too dry are low, for example 5%, wherein higher fractions of plant-based foods that are too moist or too dry negatively affect the useable output of the system. By separating the plant-based foods into different conveying sections that define separate volumes, the baking time of individual plant-based foods is now much better controlled due to their confinement in different volumes, which strongly narrows the Gaussian distribution of individual plant-based foods with regard to the baking time, such that the amount of waste due to too dry and too moist plant-based foods is significantly reduced. At the same time, the separation into different volumes allows an efficient drying on a small baking surface, wherein the vibration of the bottom ensures that the plant-based foods are separated and that the heat is evenly distributed to the surface of the plant-based foods and the moisture can be removed from the plant-based foods by evaporation.

According to another embodiment, the pre-drying section further comprises a conveying unit with a plurality of carriers for separating the conveying sections so that the plant-based foods separated in the conveying sections can be conveyed through the pre-drying section under a movement of the carriers along the conveying direction. As such, the conveying sections may be separated from each other by said carriers forming physical barriers between the conveying sections. For example, the plant-based foods may be confined into different conveying sections by the vibration of the bottom and particularly by said hot fluid stream, which causes the plant-based foods to be lifted toward the conveying unit with the conveying sections.

In yet another embodiment, the conveying unit comprises a circumferential conveyor chain, wherein the carriers protrude away from the conveyor chain so as to form the conveying sections.

In particular, a conveying velocity of the conveyor unit is adjustable. The baking time may be set by adjusting the conveying velocity, wherein lower conveying velocities correspond to longer baking times and vice versa.

According to an embodiment, the outflow bottom, the conveying sections and/or the conveying unit are components of an oven, particularly of a vibration oven of the system comprising or forming the pre-drying section.

In an embodiment, the pre-drying section is connected or connectable to a hot fluid circuit, particularly a hot gas circuit, more particularly a hot air circuit, via which the hot fluid stream is dischargeable from the pre-drying section, as well as filterable via a fluid filter, particularly a gas filter, more particularly an air filter and at least partially reintroduceable into the pre-drying section.

In another embodiment, the system comprises a plurality of pre-drying sections, wherein the energy supply unit is configured to set different pre-drying temperatures in different pre-drying sections. For example, the system may comprise three pre-drying sections, wherein each pre-drying section can be set to a respective pre-drying temperature. The respective pre-drying temperature may be essentially constant within the respective pre-drying section. The plurality of pre-drying sections may be configured such that the plant-based foods can be dried by serially passing through the plurality of pre-drying sections. A temperature gradient may be set between different pre-drying sections. In particular, the temperature gradient may be such that the temperature decreases from one pre-drying section to another.

In an example, the system comprises two pre-drying sections, namely a first pre-drying section and a second pre-drying section adjacent to each other, wherein the pre-drying sections each comprise a length of one meter and a width of 25 cm.

In a batch process as described herein, a heat flow rate of the heat flow through the first pre-drying section is between 1200 kg/h and 900 kg/h. The temperature as well as the heat flow rate in both pre-drying sections is decreased during the pre-drying to account for the decreasing moisture content of the plant-based foods. Particularly, the temperature in both pre-drying sections is:
Between 190 °C to 220 °C for a first period between 0 to 6 minutes at a first heat flow rate,
170 °C for a second period upon the first period at a second heat flow rate, wherein the second period is between 0 and 2 minutes and
170 °C for a third period upon the second period at a third heat flow rate, wherein the third period is between 0 and 30 seconds, wherein the first heat flow rate is larger than the second heat flow rate, and wherein the second heat flow rate is larger than the third heat flow rate.

In a continuous process as described herein, a first temperature in the first section can be between 190 °C and 220 °C and a first flowrate in the first section is between 900 kg/h and 1300 kg/h, wherein a second temperature in the second section is between 170 ° and 190 °C and a second flowrate in the second section is between 600 kg/h and 900 kg/h. In the continuous process, the conveying velocity through the first and the second section can be 2 m in 10 minutes, corresponding to 0.0033 m/s.

In another embodiment, the system comprises a plurality of baking sections, wherein the energy supply unit or the further energy supply unit is configured to set different baking temperatures in different baking sections.

In an embodiment, at least one pre-drying section and at least one baking section are arranged in a common housing. For example, both the pre-drying section and the baking section may be arranged in one and the same oven. The oven may comprise a common conveying line for conveying the plant-based foods from the pre-drying section to the baking section. Particularly, the oven may comprise said plurality of pre-drying sections and/or said plurality of baking sections.

According to another embodiment, the pre-dried plant-based foods are bakeable by said energy supply unit or wherein the baking section comprises a further energy supply unit for baking the pre-dried plant-based foods.

In an embodiment, the pre-dried plant-based foods can be conveyed through the baking section by means of said conveying unit or wherein the baking section comprises a further conveying unit for conveying the pre-dried plant-based foods through the baking section.

In another embodiment, the pre-dried plant-based foods can be baked by said hot fluid stream or wherein the further energy supply unit of the baking section is configured to generate a further hot fluid stream, particularly a further hot gas stream, more particularly a further hot air stream for baking the pre-dried foods. Particularly, if the pre-dried plant-based foods are baked by the hot fluid stream for pre-drying the plant-based foods in the pre-drying section, an exhaust stream of the hot fluid stream is conducted into the baking section for baking the pre-dried plant-based foods.

In an embodiment, the system further comprises a centrifugation unit configured to at least partially dewater the plant-based foods. As such, the plant-based foods can be at least partially dewatered mechanically, i.e. without thermal energy or radiation energy, which substantially improves the energy efficiency of the system. For example, in case of potato slices, 10 kg freshly cut potato slices can be dewatered to a weight of 9 kg by four subsequent rounds of centrifugation with alternating sense of the rotational direction in a receiving body comprising a lateral diameter of 47 cm extending perpendicular to a rotation axis of the centrifugation and a rotation frequency of 800-1000 rpm for 25 s per round of centrifugation. This corresponds to a reduction of the potato mass of 10% due to dewatering during the centrifugation, which substantially reduces the energy needed for the pre-drying of the plant-based foods in the pre-drying section as well as the baking of the pre-dried plant-based foods.

A degree of dewatering, the amount of water reduction of the plant-based foods by means of the centrifugation unit can be adjusted by adjusting one of the centrifugation parameters, i.e. for example the lateral diameter of said receiving body, the rotation frequency and/or the time as well as the numbers of rounds of centrifugation.

According to another embodiment, the system further comprises an additive unit configured to add additives to the plant-based foods. Particularly, the additive unit is configured to add the additives to the plant-based foods upon centrifugation. More particularly, the additive unit is configured to add the additives to the plant-based foods upon centrifugation and prior to the transfer of the plant-based foods into the pre-drying section.

In yet another embodiment, the system further comprises a mixing unit, particularly a drum, configured to receive and to mix the plant-based foods. In particular, the drum is configured to receive, mix and output the plant-based foods such that they can be or are transferred to the pre-drying section. Other systems or machines may likewise be used for the application of additives.

Preferably, prior to their transfer into the pre-drying section, stones and soil are removed from the plant-based foods and the plant-based foods are washed; peeled; sorted, particularly according to their sizes and/or cut. In particular, at the plant-based foods are dewatered, preferably mechanically by setting them into vibration and/or by centrifugation. As such, the vibration and/or centrifugation can both remove unwanted elements from the plant-based foods and reduce the water content of the plant-based foods in one step. Additives such as oils, spices, defoamers or lecithins may be added to the plant-based foods, particularly before their transfer into the pre-drying section. Preferably, the additives comprise a specific heat capacity lower than the specific heat capacity of water, particularly in the range between 1 KJ/kgK and 3 KJ/kgK. This measure contributes to a different quality of chips compare to without additives, which improves the optics, taste and the texture of the baked plant-based foods.

In particular, if the plant-based foods comprise or are potatoes, they are preferably cut into potato slices, particularly flat potato slices, with a thickness in the range between 1.3 mm and 1.7 mm, particularly between 1.1 mm and 1.7 mm, more particularly between 1.2 mm to 1.5 mm, even more particularly between 1.2 and 1.4 mm. Alternatively, the potatoes may be cut into smooth or fluted or other geometries like for example riffel or sticks. In particular, the cut potatoes washed and mechanically dewatered. Preferably, the dewatering is realized by means of centrifugation. Subsequently, the additives may be added to the dewatered potato slices, particularly in a mixing unit such as a drum configured to receive, mix and output the potato slices comprising the additives. The additives may be added by means of a spray lance arranged in a central region of said drum, wherein the additives are added and mixed under rotation of the drum around the spray lance, before the potato slices are transferred into the pre-drying region.

A second aspect of the invention relates to a method for producing baked plant-based foods, particularly baked potato chips, wherein the plant-based foods are received by a bottom of at least one pre-drying section and pre-dried by energy supplied by an energy supply unit under vibration of the bottom, and wherein the pre-dried plant-based foods are baked in at least one baking section.

In particular, the method according to the second aspect of the invention is executed using the system according to the first aspect of the invention.

Particularly, the embodiments of the first aspect of the invention apply to the second aspect of the invention and vice versa.

In an embodiment, a pre-drying temperature in the range between 140 °C and 250 °C, particularly between 170 °C and 220 °C is set by the energy supply unit in the pre-drying section. According to another embodiment, the pre-drying is such that the pre-dried foods comprise a moisture content between 5% and 25%, particularly between 10% and 20%. The moisture content may be determined in situ, for example by means of sensors, or ex situ, for example by means of samples taken out of the pre-drying section and analyzed with respect to their moisture content.

Particularly, the pre-drying and/or the baking may be executed in a continuous process as well as in a batch process. In the continuous process, plant-based foods are continuously received by and output from the pre-drying section or the baking section for a pre-determined operation time. The continuous process may for example be achieved by means of said conveying unit, particularly said conveyor chain, which continuously conveys the plant-based foods through the pre-drying section or the baking section for pre-drying the plant-based foods. The batch process provides that a pre-determined amount is received by the pre-drying section or the baking section in a first step, whereafter the plant-based foods are pre-dried or baked. In a following third step, the pre-dried or baked plant-based foods are taken out of the pre-drying section or the baking section. The first step may be achieved by means of manpower, i.e. by manually loading the food-based products into the pre-drying section or the baking section, or for example by means of said conveying unit, particularly said conveyor chain, which may be used to drive the pre-determined amount of plant-based foods into the pre-drying section or the baking section, whereafter the conveying unit is stopped, such that the second step may be executed. For the third step, the conveying unit may be used to transport the plant-based foods out of the pre-drying or the baking section.

In yet another embodiment, a baking temperature in the range between 120 °C to 150 °C, particularly between 130 °C and 140 °C, more particularly between 130 °C and 135 °C is set by the energy supply unit or by a further energy supply unit in the baking section.

According to another embodiment, the baking is such that the baked plant-based foods comprise a moisture content of less than 2.5% or equal to 2.5%, more particularly less than 2.0% or equal to 2.0%.

According to another embodiment, the baking is such that the baked plant-based foods comprise a moisture content of less than 2% or equal to 2%.

According to yet another embodiment, the plant-based foods are at least partially dewatered in the centrifugation unit prior to the pre-drying in the pre-drying section. As such, the plant-based foods may be dewatered in a more energy-efficient way by the mechanical dewatering by means of centrifugation, which typically requires much less energy compared to dewatering by thermal or radiation energy, particularly at relatively high water contents of the plant-based foods prior to being received by the pre-drying section.

In another embodiment, additives are added to the plant-based foods. For example, additives may be added to the plant-based foods between their centrifugation in the centrifugation unit and their transfer into the pre-drying section. For example, the additives comprise or are oil. Particularly, the oil added to the plant-based foods comprises sunflower oil and/or rapeseed oil and/or other oils. More particularly, the oil comprises pre-used oil taken from a conventional deep fryer for frying plant-based foods. Using this pre-used oil usually results in a more intense flavor experience perceived by the consumer. The quality of the pre-used oil can be monitored by its peroxide-level, its level of free fatty acids and of antioxidants. For example, pre-used oil comprising the following levels may be used:

Peroxide level between 0.1% and 3%.

Level of free fatty acids between 0.02% and 0.4%.

Antioxidants between 10 and 100 ppm from dosage of antioxidant itself.

For example, the amount of oil added to the plant-based foods upon their centrifugation corresponds to 0 to 13%, particularly 7.5% to 12%, more particularly 9% of the mass of the baked plant-based foods comprising less than 2.5%. For instance, the composition of the plant-based foods after pre-drying and baking is: less than 2.5% water, 83% to 98% plant-based food, particularly potato, 0 to 15% oil. Adding oil to the plant-based foods does not only result in a more intense flavor experience perceived by the consumer, but also gives the plant-based foods an enhanced texture and more appealing look.

A third aspect of the invention relates to a vibration oven. The vibration oven comprises:
a bottom configured to receive plant-based foods and configured to be set in vibration,
an energy supply unit for supplying energy to the plant-based foods for pre-drying and/or baking the plant-based foods and
a plurality of conveying sections separated from one another, such that the plant-based foods are separable in volumes defined by the conveying sections.

In particular, the vibration oven is configured to produce pre-dried and/or baked plant-based foods, particularly potato chips.

The pre-drying and/or baking is on the one hand achieved by said vibration of the bottom, that is, mechanically. On the other hand, the pre-drying and/or baking is further enhanced by means of the energy supplied to the plant-based foods by the energy supply unit. Said energy may comprise for example electromagnetic radiation, particularly thermal radiation and/or microwaves or other forms of energy, particularly as disclosed hereafter. As such, the plant-based foods are pre-dried and/or baked in the vibration oven both mechanically by means of the vibration of the bottom, as well as by the energy provided by the energy supply unit. Both the vibration as well as the energy supply may be controlled, particularly by means of an adjustment of a vibration amplitude and/or frequency of the vibration of the bottom as well as an adjustment of the amount of energy supplied to the plant-based foods by the energy supply unit. This measure contributes to enhanced control of the pre-drying and/or baking of the plant-based foods in the vibration oven.

In particular, the vibration of the bottom is such that the plant-based foods are lifted from the bottom. The vibration of the bottom may thus be so strong that the plant-based foods repeatedly and essentially randomly rotate and flip, which allows for a homogeneous drying process of the plant-based foods from all sides. This measure thus reduces the amount of food waste due to plant-based foods that are too moist or too dry.

In an embodiment, the vibration oven further comprises a conveying unit with a plurality of carriers for forming and/or separating the conveying sections, so that the plant-based foods separated in the conveying sections can be conveyed under a movement of the carriers along a conveying direction through the vibration oven.

In another embodiment, the bottom of vibration oven comprises an outflow bottom through which the energy can be supplied to the plant-based foods.

In an embodiment, the energy supply unit is configured to generate a hot fluid stream, particularly a hot gas stream, more particularly a hot air stream, such that the plant-based foods can be pre-dried and/or baked by the hot fluid stream. In particular, the plant-based foods are pre-dried by supercritical drying, or critical point drying. The plant-based foods can also be pre-dried by a superheated stream, particularly superheated steam, i.e. a stream or stream at a temperature higher than its vaporization point at the absolute pressure where the temperature is measured.

According to another embodiment, the hot fluid stream is directed through said outflow bottom. This embodiment is in particularly advantageous in that plant-based foods that are lifted by the vibration of the bottom may be pre-dried and/or baked efficiently from all sides, as they randomness of the rotating and flipping plant-based foods is further enhanced by the hot fluid stream acting on the plant-based foods, which further reduces the amount of food waste due to plant-based foods that are too dry or too moist. Particularly, the hot fluid stream may contribute to the lifting of the plant-based foods from the outflow bottom.

In an embodiment, the vibration oven further comprises a plurality of conveying sections separated from one another along a conveying direction extending through the pre-drying section, such that the plant-based foods are separable in volumes defined by the conveying sections. In particular, the separation is such that the plant-based foods arranged in different conveying sections cannot move from one conveying section to another through a physical barrier. For example, the conveying sections and their volumes may be defined by chambers which delimit the conveying sections. Typically, the production of pre-dried and/or baked plant-based foods based on air-frying goes along with a large amount of waste, since the pre-drying and/or baking time of individual plant-based foods comprised by the plant-based foods is not well controlled. This is because individual plant-based foods, for example individual potato slices, move essentially randomly in an airflow due to their different shapes and the flow dynamics of the airflow. This causes an essentially Gaussian distribution of individual plant-based foods with regard to the baking time. Typically, 50%, particularly 50% to 90% of the individual plant-based foods are baked with acceptable tolerances around a pre-determined baking time, 5% to 25% of the slices are a too moist, that is, have passed through the system too fast and 5% to 25% of the slices are too dry, that is, have passed through the system too slowly. Ideally, the respective fractions of plant-based foods that are too moist or too dry are low, for example 5%, wherein higher fractions of plant-based foods that are too moist or too dry negatively affect the useable output of the system. By separating the plant-based foods into different conveying sections that define separate volumes, the baking time of individual plant-based foods is now much better controlled due to their confinement in different volumes, which strongly narrows the Gaussian distribution of individual plant-based foods with regard to the pre-drying and/or baking time, such that the amount of waste due to too dry and too moist plant-based foods is significantly reduced. At the same time, the separation into different volumes allows an efficient drying on a small baking surface, wherein the vibration of the bottom ensures that the plant-based foods are separated and that the heat is evenly distributed to the surface of the plant-based foods and the moisture can be removed from the plant-based foods by evaporation.

According to another embodiment, the vibration oven further comprises a conveying unit with a plurality of carriers for separating the conveying sections so that the plant-based foods separated in the conveying sections can be conveyed through the vibration oven under a movement of the carriers along the conveying direction. As such, the conveying sections may be separated from each other by said carriers forming physical barriers between the conveying sections. For example, the plant-based foods may be confined into different conveying sections by the vibration of the bottom and particularly by said hot fluid stream, which causes the plant-based foods to be lifted toward the conveying unit with the conveying sections.

In yet another embodiment, the conveying unit comprises a circumferential conveyor chain, wherein the carriers protrude away from the conveyor chain so as to form the conveying sections.

In particular, a conveying velocity of the conveyor unit is adjustable. The pre-drying and/or baking time may be set by adjusting the conveying velocity, wherein lower conveying velocities correspond to longer baking times and vice versa.

In an embodiment, the vibration oven is connected or connectable to a hot fluid circuit, particularly a hot gas circuit, more particularly a hot air circuit, via which the hot fluid stream is dischargeable from the vibration oven, as well as filterable via a fluid filter, particularly a gas filter, more particularly an air filter and at least partially reintroduceable into the pre-drying section.

In another embodiment, the energy supply unit is configured to set different temperatures in different sections of the vibration oven. For example, the system may comprise three sections, wherein each section can be set to a respective temperature. The system may comprise more than three sections, for example four sections, five sections, six sections, seven sections or more. The respective temperature may be essentially constant within the respective section. The plurality of sections may be configured such that the plant-based foods can be dried and/or baked by serially passing through the plurality of sections. A temperature gradient may be set between different sections. In particular, the temperature gradient may be such that the temperature decreases from one section to another.

A fourth aspect of the invention relates to a method for producing pre-dried and/or baked plant-based foods, particularly potato chips, using the vibration oven according to the third aspect of the invention. According to the method of the fourth aspect, plant-based foods are received by said bottom of the vibration oven. The bottom is set in vibration and energy is supplied to the plant-based foods for pre-drying and/or baking the plant-based foods, wherein the plant-based foods are separable in volumes defined by a plurality of conveying sections.

A fifth aspect of the invention relates to a method for producing pre-dried potato chips, wherein potato slices are received by a bottom and wherein the potato slices are lifted and pre-dried by means of a vibration of the outflow bottom.

Particularly, the potato slices are exposed to a hot fluid flow, particularly a hot gas flow, more particularly a hot air flow for pre-drying the potato slices.

The hot fluid flow may be directed through an outflow bottom forming or being part of the bottom, such that the potato slices are further lifted by the hot fluid flow.

Exemplary embodiments are described below in conjunction with the Figures. The Figures are appended to the claims and are accompanied by text explaining individual features of the shown embodiments and aspects of the present invention. Each individual feature shown in the Figures and/or mentioned in the text of the Figures may be incorporated (also in an isolated fashion) into a claim relating to the first aspect, the second aspect, the third aspect, the fourth aspect and/or the fifth aspect according to the present invention.

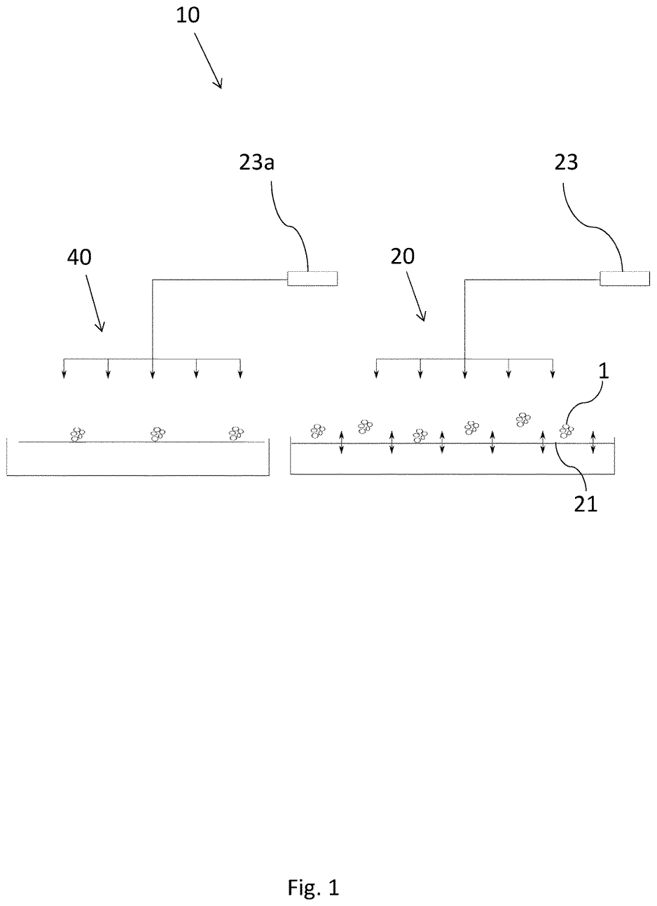

FIG. 1 shows an embodiment of the system and method according to the invention;

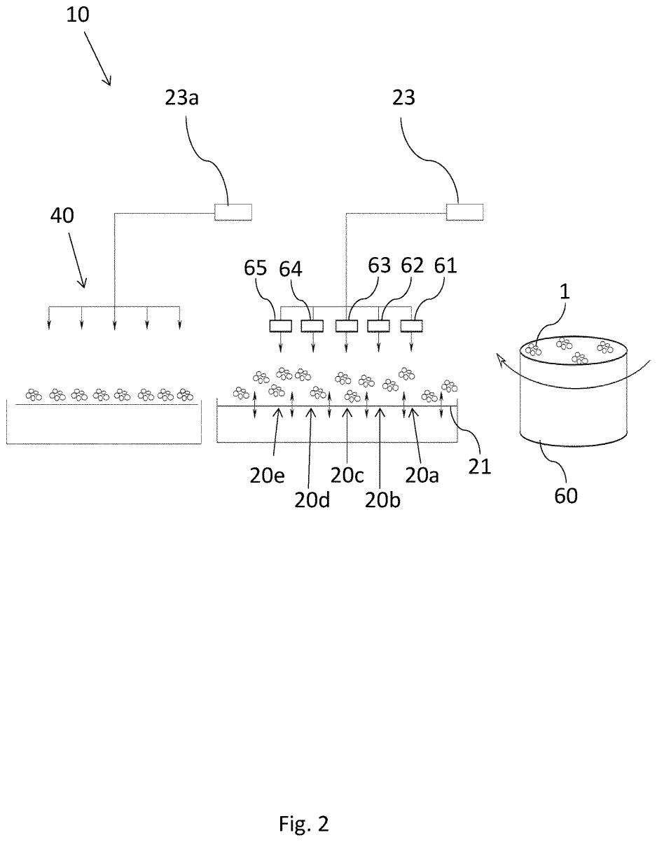

FIG. 2 shows an embodiment of the system and method according to the invention, comprising a centrifugation unit for dewatering the plant-based foods prior to their pre-drying in a plurality of pre-drying sections;

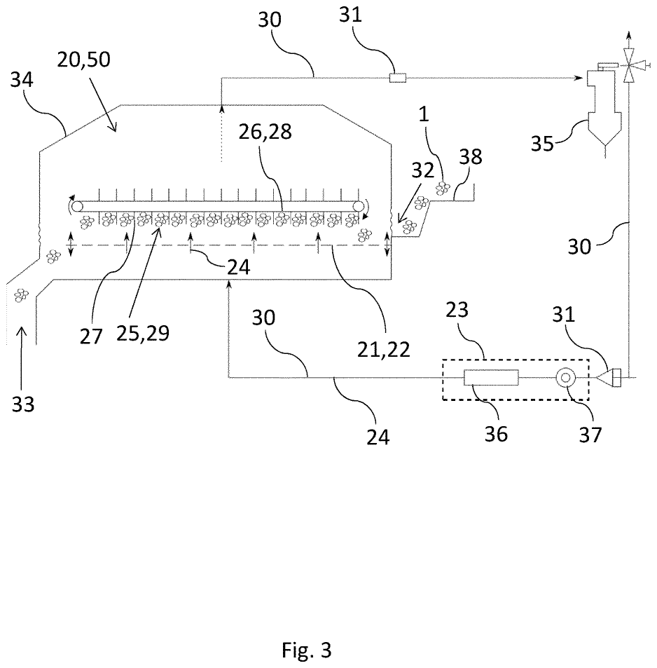

FIG. 3 shows an embodiment of the pre-drying section according to the invention, wherein the pre-drying section comprises a vibration oven; and

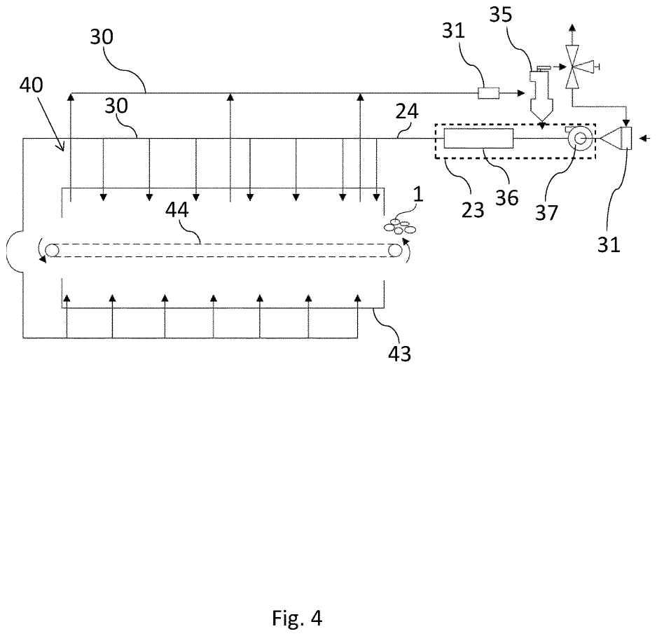

FIG. 4 shows an embodiment of the baking section according to the invention.

FIG. 1 shows an embodiment of the system 10 and the method for producing baked plant-based foods 1, particularly baked potato chips, according to the invention. The system 10 comprises a pre-drying section 20 for pre-drying provided plant-based foods 1, particularly potato slices, as well as a baking section 40 for baking the plant-based foods 1 pre-dried by the pre-drying section 20.

The pre-drying section 20 comprises a bottom 21 for receiving the plant-based foods 1. The plant-based foods 1 may be loaded onto the bottom 21 by manpower, or automatically, particularly by means of conveying means such as a conveyor line. The bottom 21 is configured to be set into vibration so as to pre-dry the provided plant-based foods 1 arranged on the vibrating bottom 21. The pre-drying is further achieved by an energy supply unit 23 configured to supply energy to the plant-based foods 1 arranged on the bottom 21. For example, the energy supplied by the energy supply unit comprises a hot fluid stream or electromagnetic radiation, particularly thermal radiation and/or microwaves. As such, the plant-based foods 1 are pre-dried in the pre-drying section 20 both mechanically by means of the vibration of the bottom 21, as well as by the energy provided by the energy supply unit 23.

In particular, the vibration of the bottom 21 causes the plant-based foods 1 to be lifted from the bottom 21, whereby the plant-based foods 1 repeatedly and essentially randomly rotate and/or flip, which causes the plant-based foods 1 to be homogeneously exposed to the energy supplied by the energy supply unit 23 from all sides.

The baking section 40 of the system 10 is configured to bake the foods pre-dried by the pre-drying section 20. To this end, the pre-dried foods may be transferred, particularly by manpower or by a conveying line, from the pre-drying section 20 into the baking section 40. The drying section 20 may merge into the baking section 40, for example by means of a common conveying line extending through the pre-drying section 20 and the baking section 40.

For the baking, energy is supplied to the pre-dried plant-based foods 1 arranged in the baking section 40. According to the present embodiment, the energy supplied to the pre-dried plant-based foods 1 in the baking section 40 is provided by a further energy supply unit 23a, wherein said energy may comprise a hot fluid stream or electromagnetic radiation, as for the energy supply unit 23 for supplying energy for the pre-drying section 20. Alternatively, the energy supplied to the pre-dried plant-based foods 1 arranged in the baking section 40 may be provided by the same energy supply unit 23 used to pre-dry the plant-based foods 1 in the pre-drying section 20.

As such, the system 10 and method according to the present embodiment allow for or comprises a two-stage drying-baking process by means of the baking section 40 serially connected to the pre-drying section 20, which allows for a higher degree of flexibility achieve the desired product properties of the baked plant-based foods 1. In particular, in the pre-drying section 20, pre-drying temperatures between 140 °C and 250 °C, particularly between 170 °C and 220 °C, are realized by means of the energy supply unit 23, whereas in the downstream baking section 40, baking temperatures between 120 °C and 150 °C, particularly between 130 °C and 140 °C, are realized by the further energy supply unit 23 a or said energy supply unit 23. Preferably, in the pre-drying section 20, the plant-based foods 1 are pre-dried such that a moisture content of the plant-based foods 1 is reduced down to the range between 5% and 25%, particularly between 10% and 20%. In the baking section 40, the pre-dried plant-based foods 1 are preferably baked such that their moisture content is reduced down to 2.5% or below 2.5%. The two-stage drying-baking process with a lower temperature in the baking section 40 compared to the pre-drying section 20 further advantageously reduces the amount of carcinogenic acrylamide formed at low moisture contents, particularly at moisture contents below 5%, which is typically enhanced at high temperatures in the presence of reducing sugars such as glucose and fructose and low moisture contents. The moisture content may be examined in-situ, particularly by means of sensors arranged in the pre-drying section 20 and/or the baking section 40, or ex situ by examining samples of the pre-dried or baked plant-based foods 1. In particular, the two-stage drying-baking process allows to adjust the baking temperature and/or the baking time based on the moisture content of the pre-dried foods determined in or upon pre-drying of the plant-based foods 1 in the pre-drying section 20, which further enhances the flexibility of the system 10 and makes it easier to achieve the desired moisture content of the baked foods, particularly moisture contents of 2% or below.

Preferably, prior to their transfer into the pre-drying section 20, stones and soil are removed from the plant-based foods 1 and the plant-based foods 1 are washed; peeled; sorted, particularly according to their sizes and/or cut. In particular, at the plant-based foods 1 are dewatered, preferably mechanically by setting them into vibration. Additives such as oils, spices, defoamers or lecithins may be added to the plant-based foods 1, particularly before their transfer into the pre-drying section 20. Preferably, the additives comprise a specific heat capacity lower than the specific heat capacity of water, particularly in the range between 1KJ/kgK and 3 KJ/kgK. This measure contributes to a different quality of chips compare to without additives, which improves the optics, taste and the texture of the baked plant-based foods 1.

In particular, if the plant-based foods 1 comprise or are potatoes, they are preferably cut into potato slices with a thickness in the range between 1.1 mm and 1.7 mm, washing of slices for starch remove, whereafter the potato slices are mechanically dewatered by means of centrifugation. Subsequently, the additives may be added to the dewatered potato slices, particularly in a mixing unit such as a drum configured to receive, mix and output the potato slices comprising the additives. Particularly, the additives may be added by means of a spray lance arranged in a central region of said drum, wherein the additives are added and mixed under rotation of the drum around the spray lance, before the potato slices are transferred into the pre-drying region 20.

FIG. 2 shows another embodiment of the system 10 and method according to the invention. In excess to the embodiment shown in FIG. 1, the system 10 according to the present embodiment further comprises a centrifugation unit 60 for dewatering the plant-based foods 1 by means of centrifugation. Fresh plant-based foods 1, for example potatoes, particularly potato slices, can be arranged in the centrifugation unit 60 particularly prior to their transfer into a plurality of serial pre-drying sections, which according to the present embodiment comprises a first pre-drying section 20a, a second pre-drying section 20b, a third pre-drying section 20c, a fourth pre-drying section 20d and a fifth pre-drying section 20e, which shall be explained in more detail below. Partially dewatering the fresh plant-based foods 1 by means of the centrifugation unit 60 allows to reduce relatively high water contents of fresh plant-based foods 1 in an energy-efficient manner, compared to a system 10 consisting of only one pre-drying section 20 or multiple pre-drying sections 20a,20b,20c,20d,20d and a baking section 40, which reduce the water content essentially be means of their associated energy supply units 23, 23a. In other words, due to the mechanical dewatering by centrifugation, less energy is needed by the energy supply units 23, 23a in order to reach a projected moisture content of the baked plant-based foods 1, particularly moisture contents of 2% or below.

The plant-based foods 1 can be moved through the pre-drying sections 20a,20b,20c,20d,20d, which particularly allows for producing baked plant-based foods 1 in a continuous process, i.e. without the need to load the pre-drying section 20 or the pre-drying sections 20 a,20b,20c,20d,20d with a batch, i.e. a certain amount, for example 80 kg of plant-based foods 1, to pre-dry this amount in the pre-drying section 20 or in the pre-drying sections 20a,20b,20c,20d,20d, and to unload the pre-dried amount in order to transfer it into the baking section 40, which is also referred to as a “batch process”. In such a process, for example, six batches with each 80 kg of plant-based foods 1 can be processed in one hour, amounting to a processing of 480 kg of plant-based foods per hour. In contrast, in the continuous process, plant-based foods 1 are continuously transferred into, moved through, and transferred out of the pre-drying section 20 or the pre-drying sections 20a,20b,20c,20d,20d, wherein the amount of plant-based foods 1 transferred into and out of the pre-drying section 20 or the pre-drying sections 20a,20b,20c,20d,20d per unit time is essentially the same. In order to move the plant-based foods 1 through the pre-drying section 20 or the pre-drying sections 20a,20b,20c,20d,20d, the vibrating bottom 21 may for example be slightly inclined such that a normal vector standing orthogonally on the bottom 21 comprises a finite inclination angle with respect to the direction of the gravitational force, such that the plant-based foods 1 are moved along the bottom 21 under vibration of the bottom 21 and action of gravity. The conveying velocity of the plant-based foods 1 inside the pre-drying section 20 can be varied by changing the inclination angle of the bottom 21, wherein larger inclination angles correspond to higher conveying velocities and vice versa.

Besides the centrifugation unit 60, the system 10 according to the embodiment of FIG. 2 further includes a plurality of heat exchangers, in the present example five heat exchangers 61,62,63,64,65, that realize a pre-drying temperature gradient along the vibrating bottom 21. The heat exchangers 61,62,63,64,65 are supplied with energy by the energy supply unit 23 and configured such that the pre-drying temperature decreases from one end of the bottom 21 to the other. As such, each heat exchanger 61,62,63,64,65 is associated to a respective pre-drying section 20a,20b,20c,20d,20e in which a respective pre-drying temperature can be realized by means of the respective heat exchanger 61,62,63,64,65. For example, a first heat exchanger 61 is configured to realize a first pre-drying temperature in the first pre-drying section 20a and corresponding pre-drying temperatures can be set in the corresponding pre-drying section be means of the corresponding heat exchanger. Particularly, if the partially dewatered plant-based foods 1 are transferred for instance into the right end of the vibrating bottom 21 shown in FIG. 2, the first heat exchanger 61 can be set to a higher pre-drying temperature than the second heat exchanger 62, and the respective pre-drying temperatures of the respective heat exchanger decrease with each heat exchanger toward the fifth heat exchanger 65. As such, the respective pre-drying temperatures of the heat exchangers can account for the decreasing water content of the plant-based foods 1, as they move through the pre-drying section 20 along the vibrating bottom 21. Moreover, in each pre-drying section 20a,20b,20c,20d,20e, a respective heat flow rate, i.e. a volume of hot gas per unit time that is conducted through the respective pre-drying section, can be set. This allows to reduce the moisture content of the plant-based foods 1 in an energy-efficient and controlled way.

In an exemplary continuous process, the partially dewatered plant-based foods 1 are transferred from the centrifugation unit 60 into the first pre-drying zone 20a, and the pre-drying temperatures in the five pre-drying sections 20a,20b,20c,20d,20e are set to 220 °C, 210 °C, 200 °C, 190 °C and 180 °C from the first pre-drying section 20a to the fifth pre-drying section 20e. The heat flow rates in the five pre-drying sections 20a,20b,20c,20d,20e are set to 130 0kg/min, 1125 kg/min, 950 kg/min, 775 kg/min and 600 kg/min from the first pre-drying section 20a to the fifth pre-drying section 20e. The conveying velocity can be set to 0.0033 m/s. Particularly, oil can be applied to the partially dewatered plant-based foods 1 before their transfer into the first pre-drying zone 20a.

As an alternative to the continuous process, the system 10 according to the present embodiment can be operated in a batch process. In the batch process, a certain amount, for example 100 kg of plant-based foods 1, is subsequently loaded onto the vibrating bottom 21, whereafter this amount is pre-dried in the pre-drying section 20 or the pre-drying sections 20a,20b,20c,20d,20d, and then unloaded in order to be transferred into the baking section 40, for baking the pre-dried plant-based foods 1. Preferably, in the batch process, the plant-based foods 1 are loaded such that they are distributed over a majority of, particularly over the entire surface of the vibrating bottom 21. For example, this may be done by keeping the vibrating bottom 21 at a finite inclination angle during the loading process, until the plant-based foods 1 are distributed over the majority of, particularly the entire surface of the vibrating bottom 21, whereafter the angle of inclination is essentially zeroed for the pre-drying process. In the same fashion, the plant-based foods 1 can be unloaded by adjusting the vibrating bottom 21 again to a finite inclination angle for transferring the pre-dried plant-based foods 1 out of the pre-drying section 20 or the pre-drying sections 20a,20b,20c,20d,20d, such that they can be baked in the downstream baking section 40. Based on a pre-drying in the pre-drying sections 20 a,20b,20c,20d,20d for 10 minutes, 500kg/h of plant-based foods 1 can be pre-drying by such a batch process.

Typically, after the pre-drying in the pre-drying section 20 or the pre-drying sections 20a,20b,20c,20d,20d, the pre-dried plant-based foods 1 comprise a moisture content within a moisture content distribution between >0 and 30%. In the baking section 40, the pre-dried plant-based foods 1 are baked by means of the further energy supply unit 23a, which may create an essentially homogeneous temperature within the baking section 40, that advantageously contributes to a reduction of the average moisture content as well as a narrowing of the moisture content distribution, as plant-based foods 1 with higher remaining moisture content lose more humidity than plant-based foods 1 at lower remaining moisture content for a fixed baking temperature. As a result, the baked plant-based foods 1 can comprise moisture contents of 2% and below, with a moisture content distribution comprising a maximum at or below 2%. To this end, for example, the baking temperature in the baking section can be kept at 135° for 3 to 10 minutes, depending on the moisture content of the pre-dried plant-based foods 1 after pre-drying in the pre-drying section.

FIG. 3 shows an embodiment of the pre-drying section 20 according to the present invention, wherein the pre-drying section 20 comprises a vibration oven 50 delimited by a housing 34. In this embodiment, the plant-based foods 1 are transferred into the vibration oven 50 at an input 32 via a feeder 38, whereafter they are received by a vibrating bottom 21 of the vibration oven 50 for pre-drying the plant-based foods 1 by means of vibration.

Moreover, the plant-based foods 1 are pre-dried by means of energy supplied by an energy supply unit 23, which in this embodiment comprises a streaming device 37 for generating a fluid stream, particularly a gas stream, more particularly an air stream. The energy supply unit 23 further comprises a heater 36 downstream the streaming device 37 for heating the fluid stream. The heated fluid stream forms a hot fluid stream 24, particularly a hot gas stream, more particularly a hot air stream which is conducted into the vibration oven 50. Said bottom 21 for receiving the plant-based foods 1 comprises a plurality of holes, through which the hot fluid stream 24 flows, such that the bottom 21 is formed as an outflow bottom 22. As indicated in FIG. 3, the hot fluid stream 24 is oriented against the direction of gravity, such that the plant-based foods 1 are further lifted from the outflow bottom 22 wherein the plant-based foods 1 are repeatedly rotated, turned over and/or flipped, which causes an efficient a homogeneous pre-drying of the plant-based foods 1 from all sides. Additionally, the plant-based foods 1 are lifted by the vibration of the outflow bottom 22. At the same time, the vibration of the outflow bottom 22 prevents the plant-based foods 1 from sticking to each other and/or to the outflow bottom 22, such that their surfaces are effectively exposed to the hot fluid stream 24, which contributes to a homogeneous pre-drying of the plant-based foods 1.

The vibration oven 50 further comprises a conveying unit 26 for conveying the plant-based foods 1 from the input 32 toward an output 33 of the vibration oven 50. The conveying unit 26 according to this embodiment comprises a circumferential conveyor chain 28 with a plurality of carriers 27 protruding away from the conveyor chain 28 so as to define and separate a plurality of conveying sections 25 or chambers 29. The plant-based foods 1 are lifted by the hot fluid stream 24 such that they are arrangeable in separate volumes defined by the conveying sections 25. The conveyor chain 28 may be actuated, such that the carriers 27 are moved along a conveying direction extending from the input 32 toward the output 33, whereby the plant-based foods 1 arranged in the conveying sections 25 are conveyed through the vibration oven 50 by said carriers 27. The carriers 27 thus represent physical barriers between adjacent conveying sections 25 which prevent the plant-based foods 1 to move between different conveying sections 25 through the carriers 27. The carriers 27 may comprise a grid, such that the hot fluid stream 24 may flow through the carriers 27. The grid size, i.e. the minimum size of openings comprised by the grid, is preferably smaller than the average size of the plant-based foods 1, such that plant-based foods 1 cannot move through the grid, whereas the hot fluid stream 24 can. As such, the carriers 27 may form cage-like chambers 29 that at least section-wise delimit adjacent conveying sections 25, as indicated in FIG. 1. In this arrangement, the plant-based foods 1 can only move between different conveying sections 25 by moving around the carriers 27. To reduce the amount of plant-based foods 1 moving between different conveying sections 25, the vibration movement of the outflow bottom 22 may be matched with a conveyor velocity of the conveyor chain 28, such that if plant-based foods 1 fall out of a conveying section 25 and down to the outflow bottom 22, they are pushed by into the same conveying section 25. As an advantageous consequence of the resulting confinement of the plant-based foods 1 in the conveying sections 25, the pre-drying time of individual plant-based foods comprised by the plant-based foods 1 that are confined in the conveying sections 25 is much better controlled compared to systems that apply a hot fluid stream 24 without such a confinement, which generally results in large fractions of plant-based foods 1 that have to be sorted out, as they are either dried too much or not enough by the hot fluid stream 1 due to uncontrolled and essentially random movements and pre-drying time of the individual plant-based foods. The pre-drying time may be set and particularly adjusted by means of a conveying velocity of the conveyor chain 28, wherein lower conveying velocities correspond to longer pre-drying times and vice versa.

The vibration oven 50 may for example extend along a length of between 15 m to 25 m, particularly between 19 m and 21 m, more particularly of 20 m, measured from the input 32 to the output 33 of the vibration oven 50. Laterally, the vibration oven 50 may comprise a width of between 0.5 m and 1.5 m, particularly between 0.9m and 1.1m, more particularly 1 m. The lateral width of the vibration oven 50 sets the maximum lateral extent of the conveying sections 25 inside the vibration oven 50.

For example, for a length of 20 m of the vibration oven 50, the conveyor chain 28 may be actuated such that the carriers 27 move at a conveying velocity of 2.5 m/min, which results in a pre-drying time of 8 minutes.

Preferably, the vibration of the outflow bottom 22 is decoupled from the conveyor chain 28, such that the outflow bottom 22 moves with respect to the conveyor chain 28 when it vibrates. In particular, the vibration of the outflow bottom 22 is such that throughout the vibration, the carriers 27 and the outflow bottom 22 are separated from each other and do not physically contact each other, which prevents that the plant-based foods 1 get stuck between the carriers 27 and the outflow bottom 22. In particular, the vibration may comprise a vibration component directed along the conveying direction, such that plant-based foods 1 are further conveyed toward the output 33 by means of the outflow bottom 22, in the case plant-based foods 1 fall back onto the outflow bottom 22.

As can further be seen in FIG. 3, the vibration oven 50 according to the present embodiment is connected to a hot fluid circuit 30 of the system 10, particularly a hot gas circuit, more particularly a hot air circuit, via which the hot fluid stream 24 is dischargeable from the vibration oven 50 and filterable via a fluid filter 31, particularly a gas filter, more particularly an air filter. Particularly, the hot fluid circuit 30 may comprise a centrifugal separator 35 for separating particles from the fluid, particularly in case the fluid comprises or is a gas such as air. The fluid may be filtered by another fluid filter 31 before entering again the energy supply unit 27 so as to be conducted back into the vibration oven 50. As such, the hot fluid circuit 30 contributes to an improved energy efficiency of the vibration 50 oven by at least partially recycling the hot fluid stream 24. Fluid that has not been recycled may be replaced by fluid contained in a reservoir, in case of air particularly from the surrounding atmosphere.

FIG. 4 shows an embodiment of the baking section 40 according to the present invention. The baking section 40 shown here is delimited by a housing 43, particularly a housing of an oven. The plant-based foods 1 pre-dried in the pre-drying section 20 are transferred into said housing 43 and arranged on a conveying unit 44 of the baking section 40 for conveying the pre-dried plant-based foods 1 through the baking section 40, wherein the plant-based foods 1 are baked by energy supplied to the plant-based foods 1. Said energy may for example be supplied from an energy supply unit 23 comprising a heater 36 and a streaming device 37, as shown in FIG. 3. Correspondingly, the plant-based foods can be baked by a hot fluid stream 24 which is conducted through the housing 43. As shown in FIG. 4, the hot fluid stream 24 may be conducted from different sides toward the plant-based foods 1 arranged on the conveying unit 44, such that the plant-based foods 1 are homogeneously exposed to the hot fluid stream 24. In alternative embodiments, the energy provided by the energy supply unit 23 comprises electromagnetic radiation, particularly thermal radiation and/or microwaves.

### LIST OF REFERENCE SIGNS

Plant-based foods 1
System 10
Pre-drying section 20
First pre-drying section 20a
Second pre-drying section 20b
Third pre-drying section 20c
Fourth pre-drying section 20d
Fifth pre-drying section 20e
Bottom 21
Outflow bottom 22
Energy supply unit 23
Further energy supply unit 23a
Hot fluid stream 24
Conveying section 25
Conveying unit of the pre-drying section 26
Carrier 27
Conveyor chain 28
Chamber 29
Hot fluid circuit 30
Fluid filter 31
Input 32
Output 33
Housing of the pre-drying section 34
Centrifugal separator 35
Heater 36
Streaming device 37
Baking section 40
Housing of the baking section 43
Conveying unit of the baking section 44
Vibration oven 50
Centrifugation unit 60
First heat exchanger 61
Second heat exchanger 62
Third heat exchanger 63
Fourth heat exchanger 64
Fifth heat exchanger 65

1. A system (10) for producing baked plant-based foods (1), particularly baked potato chips, the system (10) comprising at least one pre-drying section (20) for pre-drying provided plant-based foods (1), in particular potato slices, and at least one baking section (40) for baking the pre-dried plant-based foods (1),
wherein the pre-drying section (20) comprises a bottom (21) for receiving the plant-based foods (1), wherein the bottom (21) is configured to be set in vibration, and wherein the pre-drying section (20) comprises an energy supply unit (23) for pre-drying the plant-based foods (1) by supplying energy to the plant-based foods (1).

2. The system (10) according to claim 1, wherein a pre-drying temperature can be set in the pre-drying section (20) by means of the energy supply unit (23) and wherein the baking section (40) is configured to set a baking temperature therein, in particular wherein a temperature gradient between the pre-drying temperature and the baking temperature can be set.

3. The system (10) according to claim 1, wherein the bottom (21) of the pre-drying section (20) comprises an outflow bottom (22) through which the energy can be supplied to the plant-based foods (1).

4. The system (10) according to claim 1, wherein the energy supply unit (23) is configured to generate a hot fluid stream (24), particularly a hot gas stream, more particularly a hot air stream, such that the plant-based foods (1) can be pre-dried by the hot fluid stream (24).

5. The system (10) according to claim 4, wherein the hot fluid stream (24) is directed through said outflow bottom (22).

6. The system (10) according to claim 1, wherein the pre-drying section (20) further comprises a plurality of conveying sections (25) separated from one another along a conveying direction extending through the pre-drying section (20), such that the plant-based foods (1) are separable in volumes defined by the conveying sections (25).

7. The system (10) according to claim 6, wherein the pre-drying section (20) further comprises a conveying unit (26) with a plurality of carriers (27) for separating the conveying sections (25) so that the plant-based foods (1) separated in the conveying sections (25) can be conveyed through the pre-drying section (20) under a movement of the carriers (27) along the conveying direction.

8. The system (10) of claim 7, wherein the conveying unit (26) comprises a circumferential conveyor chain (28), wherein the carriers (27) protrude away from the conveyor chain (28) so as to form the conveying sections (25).

9. The system (10) according to claim 1, wherein the pre-dried plant-based foods (1) are bakeable by said energy supply unit (23) or wherein the baking section (40) comprises a further energy supply unit (23a) for baking the pre-dried plant-based foods (1).

10. The system (10) according to claim 1, further comprising a centrifugation unit (60) configured to at least partially dewater the plant-based foods (1) by means of centrifugation.

11. The system (10) according to claim 1, wherein the system (10) comprises a plurality of pre-drying sections (20a,20b,20c,20d,20e), wherein the energy supply unit (23) is configured to set different pre-drying temperatures in different pre-drying sections (20a,20b,20c,20d,20e).

12. The system (10) according to claim 11, wherein the energy supply unit (23) is configured to set a temperature gradient between different pre-drying sections (20a,20b.20c,20d,20e), such that the respective pre-drying temperature decreases from one pre-drying section (20a,20b.20c,20d,20e) to another.

13. The system (10) according to claim 10, further comprising an additive unit configured to add additives such as oil to the plant-based foods 1 upon centrifugation in the centrifugation unit.

14. A method for producing baked plant-based foods (1), particularly baked potato chips, wherein the plant-based foods (1) are received by a bottom (21) of at least one pre-drying section (20) and pre-dried by energy supplied by an energy supply unit (23) under vibration of the bottom (21), and wherein the pre-dried plant-based foods (1) are baked in at least one baking section (40).

15. The method according to claim 14, wherein a pre-drying temperature in the range between 140 °C to 250 °C, particularly between 170 °C and 220 °C, is set by the energy supply unit (23) in the pre-drying section (20).

16. The method according to claim 14, wherein the pre-drying is such that the pre-dried foods comprise a moisture content between 5% and 25%, particularly between 10% and 20% and/or wherein a baking temperature in the range between 120 °C to 150 °C, particularly between 130 °C and 140 °C, is set by the energy supply unit (23) or by a further energy supply unit (23a) in the baking section (40).

17. The method according to claim 14, wherein the baking is such that the baked plant-based foods comprise a moisture content of less than 2.5% or equal to 2.5%.

18. The method according to claim 14, wherein the plant-based foods are at least partially dewatered by means of centrifugation prior to the pre-drying in the pre-drying section (20).

19. A vibration oven (50), wherein the vibration oven (50) comprises:
a bottom (21) configured to receive plant-based foods (1) and to be set in vibration,
an energy supply unit (23) for supplying energy to the plant-based foods (1) for pre-drying and/or baking the plant-based foods (1) and
a plurality of conveying sections (25) separated from one another, such that the plant-based foods (1) are separable in volumes defined by the conveying sections (25).

20. The vibration oven (50) according to claim 19, further comprising a conveying unit (26) with a plurality of carriers (27) for forming and/or separating the chambers (29), so that the plant-based foods (1) separated in the conveying sections (29) can be conveyed under a movement of the carriers (27) along a conveying direction through the vibration oven (50).
